(19) United States
(12) Patent Application Publication
(10) Pub. No.: US 2013/0325834 A1
(43) Pub. Date: Dec. 5, 2013

(54) LINK ALLOCATION FOR SEARCH ENGINE OPTIMIZATION

(71) Applicant: Stephen Simburg, Seattle, WA (US)

(72) Inventor: Stephen Simburg, Seattle, WA (US)

(21) Appl. No.: 13/624,797

(22) Filed: Sep. 21, 2012

Related U.S. Application Data
(60) Provisional application No. 61/652,327, filed on May 29, 2012.

(51) Int. Cl. G06F 17/30

(52) U.S. Cl. CPC G06F 17/30864
USPC 707/706

(57) ABSTRACT

A method, system and computer program product for allocating reference resources for search engine optimization, including obtaining a maximum number of reference resources to allocate, a set of search terms, and a preferred website domain. For each member in the set of search terms, a total number of web searches, a cost per click, the current position of the preferred website domain, the current traffic, and the current number of reference resources is determined. A solver is then used to calculate an allocation of reference resources. Displaying through a computer interface are the number of additional reference resources to allocate to each member of the set of search terms, generally to maximize the expected value that could be achieved if the new position of the preferred website for particular search terms is improved.

### CROSS-REFERENCES TO RELATED APPLICATIONS

This application claims the benefit of priority to a U.S. Provisional Application No. 61/652,327, filed May 29, 2012, titled “LINK ALLOCATION FOR SEARCH ENGINE OPTIMIZATION”, naming inventor Stephen Simburg. The above-cited application is incorporated by reference.

### BACKGROUND OF THE INVENTION

The Internet is a global network of interconnected computers and devices that transmit and receive data through the use of various protocols to provide services such as email, media playback, file transfer, as well as web pages and other documents on the World Wide Web.

The World Wide Web (“web”) is described as such because web pages and documents may contain references to web pages or documents located on servers throughout the Internet. These servers are commonly referred to as nodes, and these nodes often have domain names associated with them through the use of a Domain Name Server (“DNS”) system so that virtually any available document may be accessed using a Uniform Resource Locator (“URL”), which is basically a string of alphanumeric and symbolic characters. Often, the URL includes a domain name.

Among the ways that the documents and web pages may be accessed is through their URL is by selecting a hyperlink (“link”) to view one document or web page referred to by another. Because of protocols in use on the Internet, a link can be presented in any number of ways, including as a description in words or characters, as a picture, or various other ways. Because the means of selecting a link is most commonly performed by clicking a button on the computer interface, this is typically called “clicking”, and a single access is commonly called a “click” or a “click-through”. This is despite the fact that increasing numbers of viewers are simply tapping a finger or a pointing device to a touch sensitive screen.

Because the number of web pages and other documents now available on the web exceed the ability of a human being to remember all the URL's, search services including engines have been created which attempt to index the web pages and other documents and provide the ability to search for a particular web page or document through entering search keywords or terms into a computer interface provided by the search engines. Examples of search engines include Google, Bing, and Yahoo.

Virtually every time a search engine is used for a search term, the search engine finds multiple possible URL's that could be relevant to what is being searched for, and these are returned as organic results, which are also called natural results. The search engine could even alter the search terms to correct typographical errors or common misspellings and return search results that it believes will be more relevant to what the searcher wants to find. Typically, the search engine will return numerous results and although the presentation and format may vary, the results will be presented in a way such that they are effectively numerically ranked by their position, so that the results the search engine considers most relevant are the easiest to click, and the results the search engine considers less relevant are more difficult to click and may even require the additional step for the searcher to click through a link to access a subsequent web page or document. It is well known that search results for websites receive different levels of clicks depending on their position in the results, with higher ranked results generally receiving a greater number of clicks.

Generally, those providing the web pages and documents made available on the web (website owners) would like their content to be found when someone is searching for it because there is often an economic benefit when their web pages or documents are visited more frequently, also called receiving more traffic. For instance, visitors to their web pages may purchase goods or services from them. Thus, there is often an economic incentive to have a better or higher ranking in any search engine's results, with either “1” or “top” being the best possible result. There is an expected value in terms of website traffic for any position in the search results with the higher results receiving a higher percentage of the viewers and a greater number of click-through's to the website.

Because website owners practically always have control of all the documents and web pages within a domain name, the particular URL returned by the search engine is of much less importance than whether it includes the preferred domain name or website desired by the owner.

The search engines generally do not only provide organic results. Over time, they have generally marketed to website owners the ability to place paid advertising links (paid link) to their websites near the organic search results in return for various consideration the website owners pay to search engine providers. Often these are arranged as the search engine offering the website owner certain search terms at a cost per click (CPC), where the website owner pays a marginal amount for each click-through to their website. The rate for the CPC is often set by market forces, and popular search terms generally cost more than less popular search terms. Therefore, the viewership that a website receives from a natural result also has a market value. Additionally, it is well known that searchers generally prefer to click on an organic result rather than a paid link, particularly if the organic link seems more relevant to what they are searching for.

Search engines use an algorithm to determine the ranking of search results. The most common algorithms are modeled after the academic system of determining the importance of a given work by the number of other works that cite it. Generally, in search results, the position of a website relevant to a search keyword is determined by the number of other websites linking to it. For example, Google uses the PageRank algorithm that follows the link counting principle. Search services that disclose their algorithms, such as SEOmoz, have released “open index” programs that assess the position of a website in search results and the number of links that are not on that website (competing websites). In general, different search services provide different information when queried, but currently most of the search engines do not fully disclose the algorithms used to rank organic search results.

When it comes to getting website traffic from the organic results of search engines, there are two fundamental challenges: identifying which search terms (terms) provide the best opportunity, and then finding a way to get enough links to improve the rank of the preferred website, particularly to be presented on the first page of organic search results and not requiring the searcher to click-through to an additional page of organic search results.

### BRIEF SUMMARY OF THE INVENTION

A method, system and computer program product for allocating reference resources for search engine optimization.

### BRIEF DESCRIPTION OF THE DRAWINGS

FIG. 1 is a system diagram of an embodiment showing the relationships of the subsystems.

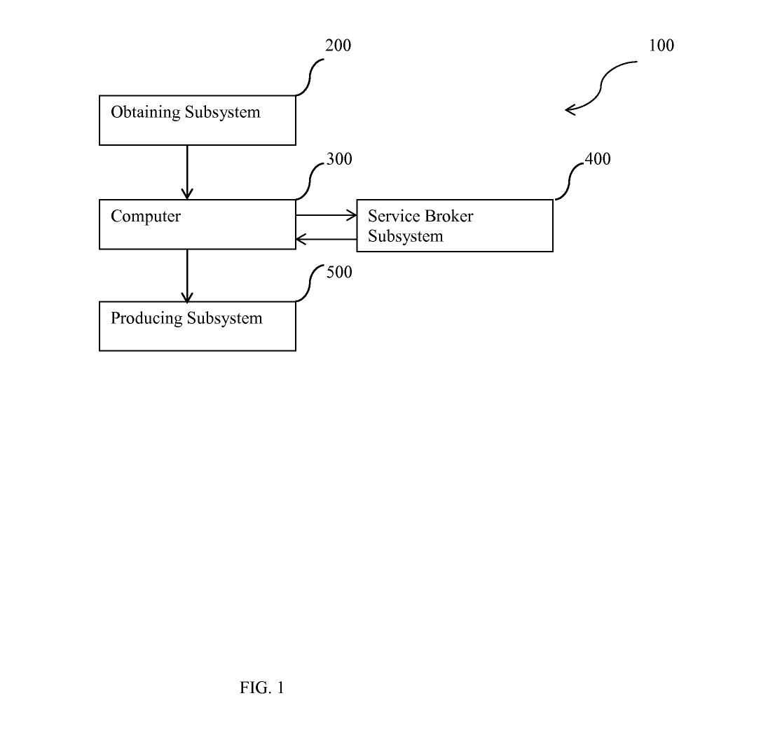

FIG. 2 is a flow diagram of the required constraints in one embodiment.

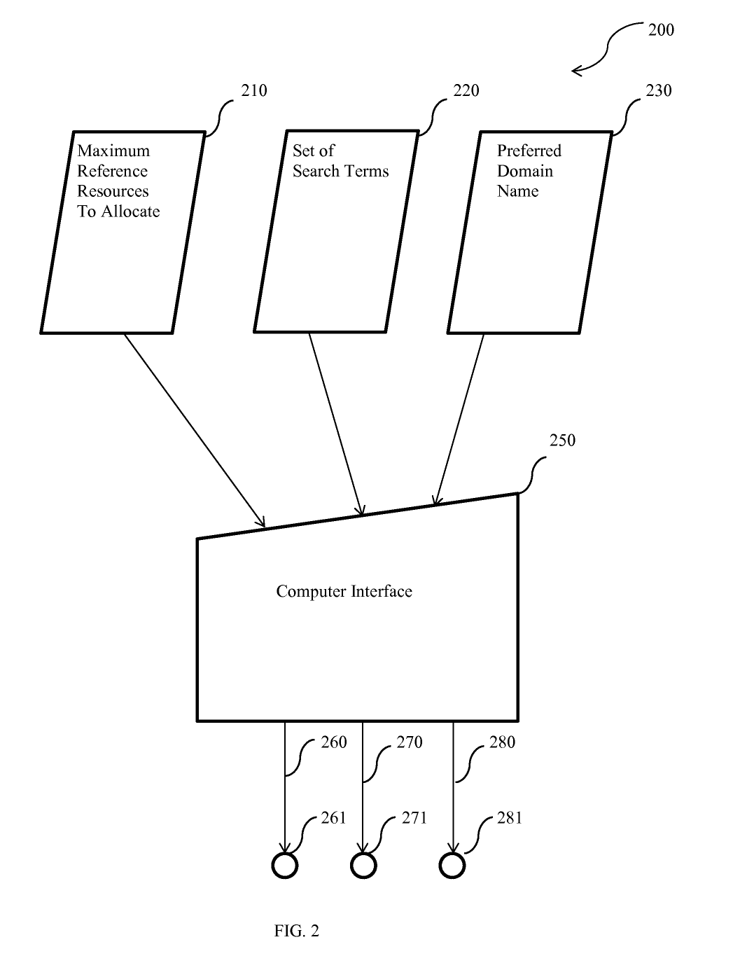

FIG. 3. is a diagram of an embodiment of a nonabstract computer programmed to performed instructions in a control routine to obtain inputs from a computer interface, determine additional empirical inputs from a service broker, calculate with an solver, and produce output.

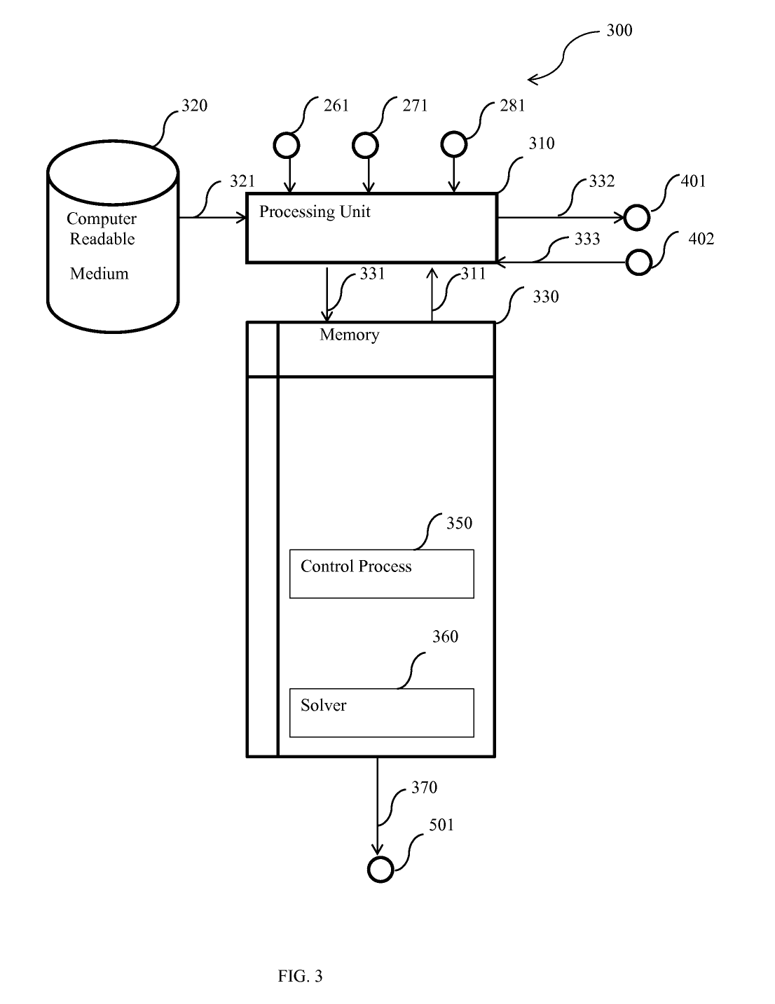

FIG. 4. is a flow diagram of an embodiment with a service broker to collect empirical inputs from various providers.

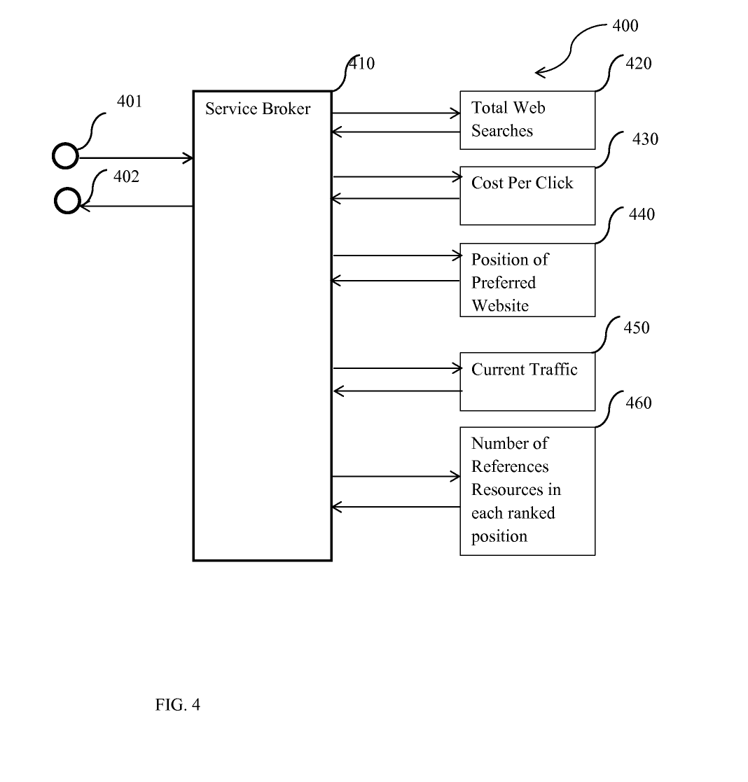

FIG. 5. is a flow diagram of an embodiment that produces output of the optimal allocation through a computer display interface.

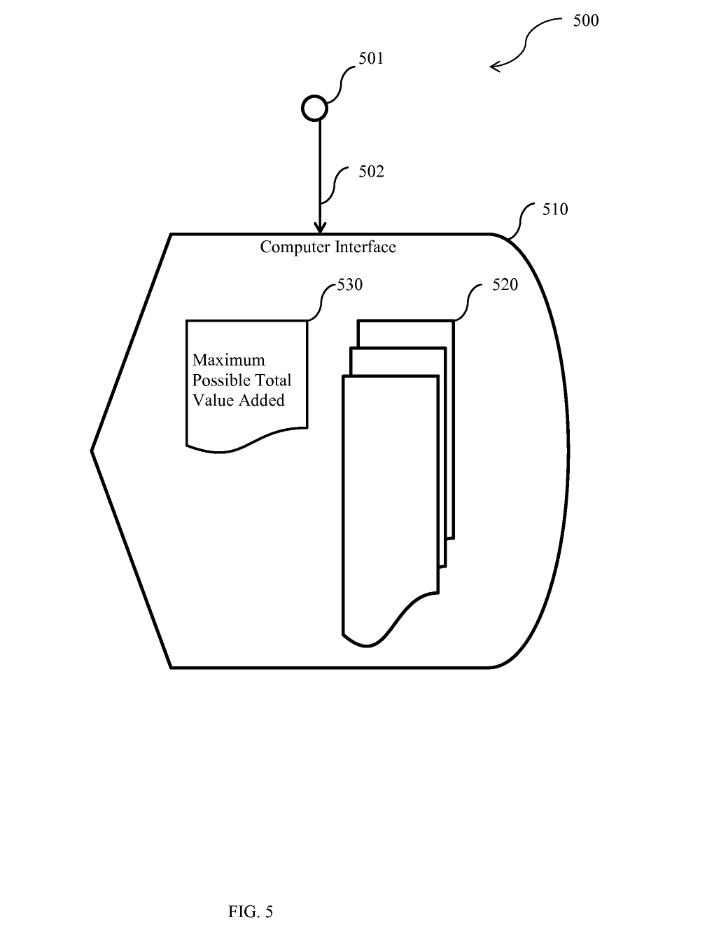

### DETAILED DESCRIPTION OF INVENTION

Website owners need a way to be able to make efficient decisions on allocating resources to improve their position in the organic results of search engines. The activity of adding additional links to websites for the purpose of improving the position in search engine rankings, known as “link building” is confounded by scale and complexity. Normally website owners lack the level of skill in the art to make these decisions, and they would involve Search Engine Optimization (SEO) professionals. Those SEO Professionals of skill in the art would ordinarily have several years of experience in SEO and advanced training, such as a graduate education including operations research.

There is a lot for the SEO professional or SEO manager to do before the link building process starts. The steps comprise keyword research, content creation, link allocation, and link building to improve ranking in search results.

First the managers decide which consumer search phrases to target (search terms or “keywords”). There may be thousands of relevant keywords for any particular website. For example, a surf shop might want to have keywords for different products and types of services (eg, surfboards, board rentals). Existing tools in the market aid in keyword selection, and the manager may want to employ one of these tools. If necessary, the manager will build out content on the website relevant to those keywords.

Next, the SEO manager engages in link building. It is right before this step that the invention becomes involved, and this new step is called “link allocation”. In order to engage in link building the SEO manager must decide which content to request links for, which keywords to emphasize, and thus what type of websites to request links from.

To perform link allocation, a method is needed to calculate the value of advancing in position in search results and to display the number of links to add to each keyword in order to achieve optimal impact. The link allocation report is optimized to deliver the maximum value from link building with the least investment in link building.

Take as an example using the recreation related keywords previously mentioned: “surfboards” and “board rentals”. Let's say the term “surfboards” gets 1,000,000 searches a month, while the term “board rentals” gets 50,000 searches a month. Improving value depends upon the current position of the preferred website for the particular search term, and the links that would be required to improve position, and not merely the search volume.

The term “surfboards” with 1,000,000 monthly searches would be very difficult to ever rank on, which could mean that a website owner would go to great lengths and expense optimizing the content on their website, doing targeted link building, and still end up not making the first page of search engine organic results, and consequently having no increase in traffic. However, those same efforts, had they been directed at the term “board rentals” with 50,000 searches per month, would have led to top rankings, sizeable traffic increases, and income from this new audience. Some clicks on a winnable term are better than no clicks on an unwinnable term—even if the unwinnable term has significantly higher volume.

An embodiment of the invention produces a link allocation report, which tells the SEO manager that “board rentals” should be their priority and how many links to build to their board rentals website content. The SEO manager also gets a list of any second priority, third priority, and so on, as well as how many links to build for those other keywords. Once the SEO manager has the link allocation report, they can simply go about the process of link building for the “board rentals” content that their website is going to appear more prominently in searches for. The SEO manager's time is saved because they are no longer wasting time on content that will never rank and no longer wasting time building unnecessary links.

Moving up in ranking for search results has a different value for each search phrase and for each website in the search rankings. The reason is that different search results have different levels of viewership, the viewership is valued differently in the market depending on the search term, and each website has a different number of links and positional ranking relevant to each keyword.

Not only does advancing from each position in search ranking have a different marginal value, but each additional link also has a different marginal value based on the website's current position, number of links needed to move up in ranking, and the market value of a higher position. Therefore, what is needed is a system to calculate the marginal value of advancing in position and allocate the number of links to add to each keyword.

An embodiment of the system described assesses relative position of the website in search rankings and reports the ideal resource allocation of additional links to a website related to each keyword.

An embodiment of the system described uses a mathematical software engine (“solver”) to achieve the ideal resource allocations. The solver is provided with a set of inputs, goals and constraints. The inputs, goals and constraints are set up as a type of combinatorial optimization calculation. This type of mathematical problem is generally known as a knapsack problem.

In one embodiment, a computer related medium 320 is first used to load instructions into a computer 300 using a means 321 of loading the instructions that interacts with the processing unit 310 to put the instructions into memory 330 using a CPU to memory connection 311. The instructions loaded include a control routine 350 and the instructions necessary to execute a solver 360. Both the control routine 350 and the solver 360 in one embodiment could simply be Microsoft Excel with the Solver Add-In installed. The control routine 350 must be programmed to perform the steps of the method, which in one embodiment could be performed with an Excel macro.

Using a computer interface 250, a user selects a maximum amount of reference resources to allocate 210, a set of search terms 220 and their preferred domain name 230. A set of search terms might also be called a keyword population. A preferred domain name might also be called a preferred website.

The maximum amount of reference resources to allocate 210 is provided to the processing unit 310 through a connection point 261. The set of search terms 220 is provided to the processing unit 310 through a connection point 271. The preferred domain name 230 is provided to the processing unit 310 through a connection point 281. The processing unit 310 reads the maximum amount of reference resources to allocate 210 from connection point 261, the set of search terms 220 from connection point 271, and the preferred domain name 230 from connection point 281 and stores these values into memory 330 using a CPU to memory connection 311.

The processing unit 310 accesses the stored values using the control routine 350 to provide those values using a CPU to service broker connection 332 through a service broker connection point 401. In one embodiment, the service broker 410 resides within control routine 350; for instance, currently search engines services like Google will not provide current rank, so the control routine 350 could contain instructions to directly query an open index like SEOmoz. Similarly, search services like SEOmoz may not have relevant CPC data, so the control routine 350 could contain instructions to directly query a search engine service like Google. This is analogous for any query performed by the service broker 410. In some embodiments, it is possible that the empirical data being queried resides locally or has been cached, whether within memory 330 or on a computer readable medium 320.

The service broker 410 receives the stored values through connection point 401.

For each member in the set of search terms 220, a search service is queried to return the total web searches 420, which is returned through service broker 410 to connection point 402. In one embodiment, the search service queried is Google. Total Web Searches and Total Search Level are synonymous.

For each member in the set of search terms 220, a search service is queried to return the cost per click 430, which is returned through service broker 410 to connection point 402. In one embodiment, the search service queried is Google. The cost per click 430 is used as the basis for calculating the value added by additional reference resources because it is assumed if the market for paid advertisements for particular keywords has set a price, it approximates the value to the website owner of having similar positioning with organic results.

For each member in the set of search terms 220, a search service is queried to return the position of preferred website 440, which is returned through service broker 410 to connection point 402. In one embodiment, the search service queried is SEOmoz.

For each member in the set of search terms 220, a search service is queried to return the current traffic 450, which is returned through service broker 410 to connection point 402. In one embodiment, current traffic 450 is estimated by using a formula that multiplies total web searches 420 by Click-Through-Rate (CTR), where CTR is a formula that is a smaller percentage value as position of preferred website 440 gets worse. In one embodiment, the CTR formula is to divide fifty percentage points by the position of preferred website 440 and then subtract five percentage points.

For each member in the set of search terms 220, a search service is queried to return the current number of reference resources in each ranked position 460, which is returned through service broker 410 to connection point 402. In one embodiment, the search service queried is SEOmoz. In one embodiment, the only ranked positions returned are the first ten, because typically after the first ten ranked positions, any further search results would be on another page thus requiring an additional step to click to see them. All of these reference resources are considered competitors, except for the number of reference resources that corresponds to the position of the position of preferred website 440. In embodiments where the only reference resource is a link, the current number of reference resources in each ranked position 460 is the same as the number of links by position.

In one embodiment, the calls to the search services are optimized to be performed efficiently, to request an array of values or for a set of search terms all at one time.

From connection point 402, the values are fed into a solver engine. In one embodiment, the solver 360 calculates the maximum possible total value added 530 achieved by variations in allocating links given a constraint of the maximum number of additional link resources to allocate, and then introduces the secondary goal of minimizing the number of links constrained to not reduce the maximum possible total value.

The solver 360 uses the processing unit 310 to store the maximum possible total value added 530 and the number of additional reference resources to allocate 520 in memory 330 through CPU to memory connection 311. The processing unit 310 produces the total value added 530 and the number of additional reference resources to allocate 520 through a connection to a result computer interface 370 to connection point 501. From connection point 501, these values are produced on computer interface 510.

A reference resource is a more general description of a hyperlink, or link, All links are reference resources, but not all reference resources are links. A reference resource could be weighted to account for the influence of links forming nodes between other related websites that are influential to search engine algorithms.

What is claimed is:

1. A computer-implemented method of allocating reference resources for search engine optimization the method comprising:
obtaining through a computer interface a maximum number of additional reference resources to allocate, a set of search terms, and a preferred website domain;
determining for each member in said set of search terms, a total number of web searches for each said member, a cost per click for each said member, a current position of the said preferred website domain for each said member, a current traffic for each said member, and a current number of references resources for each position for each said member;
calculating with a solver; and
producing through a computer interface for each said member of said set of search terms, the number of additional reference resources to allocate to each said member.

2. The method of claim 1, wherein a reference resource comprises a link.

3. The method of claim 2, wherein the solver calculates a maximum possible total value added achieved by variations in allocating links given a constraint of a maximum number of additional link resources to allocate, and then introduces a secondary goal of minimizing the number of additional link resources constrained to not reduce the maximum possible total value.

4. A computer readable medium comprising a set of instructions which, when executed by a computer, cause the computer to perform a method of allocating reference resources for search engine optimization the method comprising:
obtaining through a computer interface a maximum number of additional reference resources to allocate, a set of search terms, and a preferred website domain;
determining for each member in said set of search terms, a total number of web searches for each said member, a cost per click for each said member, a current position of the said preferred website domain for each said member, a current traffic for each said member, and a current number of references resources for each position for each said member;
calculating with a solver; and
producing through a computer interface for each said member of said set of search terms, the number of additional reference resources to allocate to each said member.

5. The computer readable medium of claim 4, wherein a reference resource comprises a link.

6. The computer readable medium of claim 5, wherein the solver calculates a maximum possible total value added achieved by variations in allocating links given a constraint of a maximum number of additional link resources to allocate, and then introduces a secondary goal of minimizing the number of additional link resources constrained to not reduce the maximum possible total value.
